(19) United States
(12) Patent Application Publication
(10) Pub. No.: US 2025/0310920 A1
(43) Pub. Date: Oct. 2, 2025

(54) TECHNOLOGY FOR SEARCHING FOR PROXIMATE TERMINAL DEVICE

(71) Applicant: RAKUTEN SYMPHONY, INC., Tokyo (JP)

(72) Inventor: Ji YOUN, Seoul (KR)

(21) Appl. No.: 18/249,059

(22) PCT Filed: Jul. 15, 2022
(86) PCT No.: PCT/KR2022/010399

§ 371 Date: Jun. 24, 2025

(51) Int. Cl. H04W 64/00

(52) U.S. Cl. CPC H04W 64/00

(57) ABSTRACT

An electronic device according to various embodiments of the present disclosure may be configured to receive, from a first terminal device, a request for a list including at least one terminal device close to the first terminal device, a logical address of a communication network to which the first terminal device is connected, and a physical address of a communication device to which the first terminal device is connected, identify the at least one terminal device close to the first terminal device among the one or more second terminal devices, based on the logical address and the physical address of the first terminal device, and logical addresses, physical addresses, and flags respectively related to the one or more second terminal devices, and transmit the list including the at least one identified terminal device to the first terminal device.

### TECHNICAL FIELD

The present disclosure relates to a technology for searching for a proximate terminal device based on a network address or the like.

### BACKGROUND

Conventionally, Bluetooth Low Energy (BLE) or Global Positioning System (GPS) technology has been used to search for another terminal device located within a short distance from a specific terminal device. The BLE technology has the advantages of reduced power consumption and a short operating cycle, but has drawbacks of very narrow range of availability (for example, 10 m) and low transmission rates. The GPS technology has a drawback in that accuracy of a location is reduced for a short distance or indoors.

### DISCLOSURE

### Technical Problem

The present disclosure provides a method wherein, even when a specific terminal device is located indoors, another terminal device close (proximate) to the specific terminal device may be accurately searched.

### Technical Solution

An electronic device according to one embodiment of the present disclosure may include a communication circuit, one or more memories, and one or more processors. The communication circuit may be communicatively connected with a first terminal device and one or more second terminal devices. The one or more memories may store logical addresses of communication networks respectively associated with the one or more second terminal devices, physical addresses of communication devices respectively associated with the one or more second terminal devices, and flags respectively indicating whether the one or more second terminal devices are activated. The one or more processors may receive, from the first terminal device, a request for a list including at least one terminal device close to the first terminal device, a logical address of a communication network to which the first terminal device is connected, and a physical address of a communication device to which the first terminal device is connected. The one or more processors may identify the at least one terminal device close to the first terminal device among the one or more second terminal devices, based on the logical address and the physical address of the first terminal device, and the logical addresses, the physical addresses, and the flags associated with the one or more second terminal devices, respectively. The one or more processors may transmit the list including the at least one identified terminal device to the first terminal device.

A method according to an embodiment of the present disclosure may include receiving, from a first terminal device, a request for a list including at least one terminal device close to the first terminal device, a logical address of a communication network to which the first terminal device is connected, and a physical address of a communication device to which the first terminal device is connected. The method may include identifying the at least one terminal device close to the first terminal device among the one or more second terminal devices, based on the logical address and the physical address of the first terminal device, and logical addresses, physical addresses, and flags respectively associated with the one or more second terminal devices, respectively. The method may include transmitting the list including the at least one identified terminal device to the first terminal device.

A non-transitory computer-readable recording medium in which a program to be executed on a computer is recorded, according to an embodiment of the present disclosure, the program may include an executable command which, when executed by one or more processors, causes the processors to receive, from a first terminal device, a request for a list including at least one terminal device close to the first terminal device, a logical address of a communication network to which the first terminal device is connected, and a physical address of a communication device to which the first terminal device is connected. The program may include an executable command which, when executed by one or more processors, causes the processors to identify the at least one terminal device close to the first terminal device among the one or more second terminal devices, based on the logical address and the physical address of the first terminal device, and logical addresses, physical addresses, and flags respectively associated with the one or more second terminal devices, respectively. The program may include an executable command which, when executed by one or more processors, causes the processors to transmit the list including the at least one identified terminal device to the first terminal device.

### Advantageous Effects

According to at least one embodiment of the present disclosure, a proximate terminal device of a range wider than the available range (or available radius) of BLE may be searched.

According to at least one embodiment of the present disclosure, even when a terminal device is located in an indoor environment, a proximate terminal device may be accurately searched. For example, a proximate terminal device located in the same building as a specific terminal device may be more accurately searched.

### BRIEF DESCRIPTION OF DRAWINGS

FIG. 1 illustrates a system according to an embodiment of the present disclosure.

FIG. 2 is a block diagram illustrating an electronic device according to an embodiment of the present disclosure.

FIG. 3 is a flowchart illustrating operations of a system according to an embodiment of the present disclosure.

FIG. 4 is a flowchart illustrating operations of an electronic device according to an embodiment of the present disclosure.

FIG. 5 is a flowchart illustrating operations of an electronic device according to an embodiment of the present disclosure.

### DETAILED DESCRIPTION

Embodiments of the present disclosure are illustrated for describing the technical spirit of the present disclosure. The scope of the claims according to the present disclosure is not limited to the embodiments described below or to the detailed descriptions of these embodiments.

All technical or scientific terms used herein have meanings that are generally understood by a person having ordinary knowledge in the art to which the present disclosure pertains, unless otherwise specified. The terms used herein are selected for only more clear illustration of the present disclosure, and are not intended to limit the scope of claims in accordance with the present disclosure.

The expressions “include”, “provided with”, “have” and the like used herein should be understood as open-ended terms connoting the possibility of inclusion of other embodiments, unless otherwise mentioned in a phrase or sentence including the expressions.

A singular expression can include meanings of plurality, unless otherwise mentioned, and the same is applied to a singular expression stated in the claims.

The terms “first”, “second”, etc. used herein are used to identify a plurality of components from one another, and are not intended to limit the order or importance of the relevant components.

The expression “based on” used herein is used to describe one or more factors that influences a decision, an action of judgment or an operation described in a phrase or sentence including the relevant expression, and this expression does not exclude additional factor influencing the decision, the action of judgment or the operation.

When a certain component is described as “coupled to” or “connected to” another component, this should be understood as having meaning that the certain component may be coupled or connected directly to the other component or that the certain component may be coupled or connected to the other component via a new intervening component.

Hereinafter, embodiments of the present disclosure will be described with reference to the accompanying drawings. In the accompanying drawings, like or relevant components are indicated by like reference numerals. In the following description of embodiments, repeated descriptions of the identical or relevant components will be omitted. However, even if a description of a component is omitted, such a component is not intended to be excluded in an embodiment.

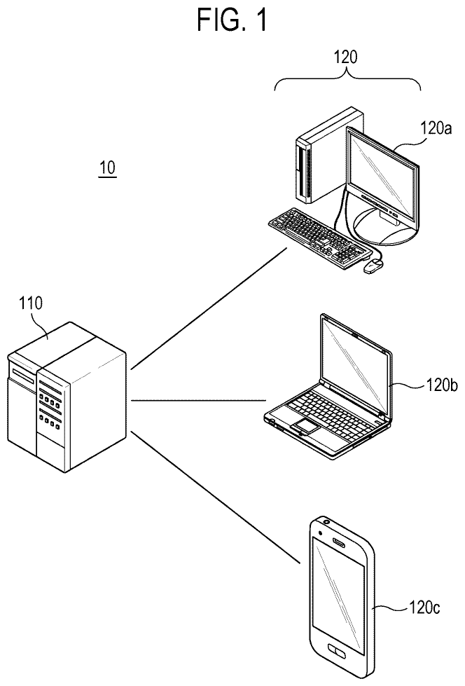

FIG. 1 illustrates a system 10 according to an embodiment of the present disclosure. The system 10 according to the embodiment of the present disclosure may include an electronic device 110 and a plurality of terminal devices 120. The system 10 may be configured to search for another terminal device close to a specific terminal device and to perform file transmission between proximate (that is, located within a short distance) terminal devices. The system 10 may be a system for operating a file transmission program. Although it will be assumed herein that the file transmission program performs file transmission between proximate terminal devices, the file transmission function itself is not limited thereto, and file transmission may also be performed between terminal devices that are not close by.

The electronic device 110 according to an embodiment may be a server configured to manage the file transmission program. The electronic device 110 may be communicatively connected to a plurality of terminal devices 120 having the file transmission program installed therein, thereby transmitting or receiving various information and materials. For example, the electronic device 110 may receive a specific file from a first terminal device 120a according to a request for transmitting the specific file from the first terminal device 120a to a second terminal device 120b, and may transmit the received specific file to the second terminal device 120b under a specific condition. The above-mentioned specific condition will be described later.

The plurality of terminal devices 120 according to an embodiment may include various forms of devices. The plurality of terminal devices 120 may include, for example, a computer device (for example, the terminal device 120a in FIG. 1), a laptop (for example, a terminal device 120b in FIG. 1), a portable communication device (smartphone) (for example, a terminal device 120c in FIG. 1), a portable multimedia device, a wearable device, or a home appliance. The terminal devices according to an embodiment of the present disclosure are not limited to the above-mentioned devices. The plurality of terminal devices 120 according to various embodiments may be connected to a communication network. The communication network may include, for example, a wired LAN, a wireless LAN (for example, Wi-Fi network), or a WAN. Although it has been assumed herein that the number of terminal devices is three for illustration, the number of terminal devices is not limited thereto, and may be two, or four or more.

The electronic device 110 may store a logical address associated with each of the plurality of terminal devices 120, a physical address associated with each of the plurality of terminal devices 120, and/or a flag indicating whether each of the plurality of terminal devices 120 is activated. The logical address and physical address associated with each of the plurality of terminal devices 120 may be information received from the corresponding terminal devices 120 and then stored. The flag indicating whether each of the plurality of terminal devices 120 is activated may be information stored by the electronic device 110. Upon receiving the corresponding logical address or physical address from each of the plurality of terminal devices 120, the electronic device 110 may change a value of the flag for the relevant terminal device 120.

The logical address may be a logical address of a communication network to which a terminal device 120 is connected. For example, the logical address may be an Internet Protocol (IP) address of a communication network to which a terminal device 120 is connected. For example, the logical address may be an IP address of a communication device associated with a communication network to which a terminal device 120 is connected. The logical address may be a serial number used to identify the communication network to which the terminal device 120 is connected (belongs). For example, the communication device may be a router or an access point. As used herein, the logical address of a terminal device 120 may refer to the logical address (for example, IP address) of a communication network to which the terminal device 120 is connected. The “logical address of a terminal device” may be used interchangeably with the “logical address associated with a terminal device”.

The physical address may be a physical address of a communication device to which a terminal device 120 is connected. For example, the physical address may be a Media Access Control (MAC) address of a communication device to which a terminal device is connected. The MAC address is a unique identification address for identifying the communication device associated with a communication network, and may be a unique identification address assigned to a LAN card included in the communication device. According to an embodiment, the electronic device 110 may further receive a unique identification address of a communication device associated with the plurality of terminal devices 120. For example, the unique identification address may be a Service Set Identifier (SSID) or a Basic Service Set Identifier (BSSID) of an access point. The physical address of the terminal device 120 may refer to the physical address (for example, a MAC address) of the communication device of the communication network to which the terminal device 120 is communicatively connected. The “physical address of a terminal device” may be used interchangeably with the “physical address associated with a terminal device”.

The flag indicating activation or not may be information indicating whether a terminal device 120 is in an activated state or in an inactivated state. For example, in case a terminal device 120 executes a file transmission program, the electronic device 110 may activate the flag of the corresponding terminal device. For example, in case a user is logged in to the file transmission program through a terminal device 120, the electronic device 110 may activate the flag of the corresponding terminal device. In an embodiment, the electronic device 110 may recognize that the timepoint at which the logical address and/or physical address of the terminal device 120 is received is the timepoint at which the file transmission program is executed (or the timepoint of logging in to file transmission program), and may then activate the flag of the corresponding terminal device. That is, the timepoint at which the logical address and/or physical address of the terminal device 120 is received from the terminal device 120 may be set to be as a triggering timepoint to activate the flag of the corresponding terminal device.

In an embodiment, an activated flag may be set such that the same is automatically deactivated when a predetermined period of time lapses from the timepoint of the activation. For example, a flag may be automatically deactivated after one minute from the timepoint of activation. Of course, this predetermined period of time is for illustration and can be freely set by the user.

An example in which a first user transmits a specific file to a second user by using a system 10 according to the present disclosure will be described. It will be assumed that the first user wants to transmit the specific file through a first terminal device 120a to the second user who works in the same office and uses a second terminal device 120b. The first user may execute the file transmission program through the first terminal device 120a, and the second user may execute the same through the second terminal device 120b. In this case, each of the first terminal device 120a and the second terminal device 120b may transmit a logical address (an IP address) of a connected communication network and/or the physical address (for example, a MAC) of a connected communication device (for example, router) to an electronic device 110. The electronic device 110 may activate a flag of the first terminal device 120a and that of the second terminal device 120b in response to receiving the logical address and physical address from each of the first terminal device 120a and the second terminal device 120b. This may indicate that the first terminal device 120a and the second terminal device 120b are in an activated state in which the same can transmit or receive a specific file. In this state, the first user of the first terminal device 120a may search for at least one terminal device close to the first terminal device 120a for the file transmission program. If the first terminal device 120a and the second terminal device 120b are connected to an access point installed in the same office, the first terminal device 120a and the second terminal device 120b may have the same physical address (a MAC address), and, in that case, the electronic device 110 may determine that the second terminal device 120b is close to (located within a short distance from) the first terminal device 120a. Therefore, the first user may transmit the specific file to the second terminal device 120b located within a short distance through the first terminal device 120a. That is, from the perspective of the first and second users, they may transmit the specific file by accessing the file transmission program, searching for a proximate terminal device, and simply selecting a terminal device that has been found.

According to an embodiment of the present disclosure, the electronic device 110 may use the logical address and/or physical address of the plurality of terminal devices 120 so as to determine whether they are close by (that is, located within a short distance from each other). In addition, the flag of each of the plurality of terminal devices 120 may be used to identify whether each of the plurality of terminal devices 120 is in a state in which file transmission is possible, that is, in an activated state, thereby efficiently searching for a terminal device located within a short distance from a specific terminal device.

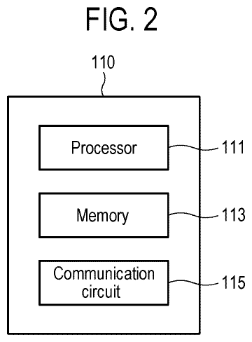

FIG. 2 is a block diagram of an electronic device 110 according to an embodiment of the present disclosure. The electronic device 110 according to the embodiment may include one or more processors 111 and/or one or more memories 113. Some of the illustrated components of the electronic device 110 may be omitted or replaced. The expression “processor 111” may denote a set of one or more processors 111 unless otherwise mentioned specifically. The expression “memory 113” may denote a memory 113 or a set of more memories 113 unless explicitly described otherwise given the context.

The processor 111 may perform computation or data processing associated with control and/or communication of respective components of the electronic device 110. The processor 111 may be operatively connected to components of the electronic device 110, for example. The processor 111 may store commands or data received from another component of the electronic device 110 in the memory 113, may load and process commands or data stored in the memory 113, and may store resulting data back in the memory 113. The memory 113 may store commands regarding operations of the processor 111.

The memory 113 may store various information. The memory 113 may store logical addresses and physical addresses associated with the plurality of terminal devices, respectively, and flags indicating whether the plurality of terminal devices are activated. In this case, the memory 113 may store not only the logical address of the communication network to which each of the plurality of terminal devices 120 is currently connected and the physical address of a currently connected communication device, but also a logical address of a previously connected communication network and a physical address of a previously connected communication device. That is, the memory 113 may store the record of logical addresses and physical addresses of each of the plurality of terminal devices 120.

According to an embodiment, the electronic device 110 may further include a communication circuit 115. The communication circuit 115 may establish a communication channel with an external device (for example, a terminal device 120) and may transmit or receive various data with the external device. According to various embodiments, the communication circuit 115 may include a cellular communication module so as to connect to a cellular network (for example, 3G, LTE, 5G, Wibro, or Wimax). According to various embodiments, the communication circuit 115 may include a short-distance communication module and may transmit or receive data with an external device by using short-distance communication (for example, Wi-Fi, Bluetooth, Bluetooth Low Energy (BLE), UWB (Ultra Wide Band)), but is not limited thereto.

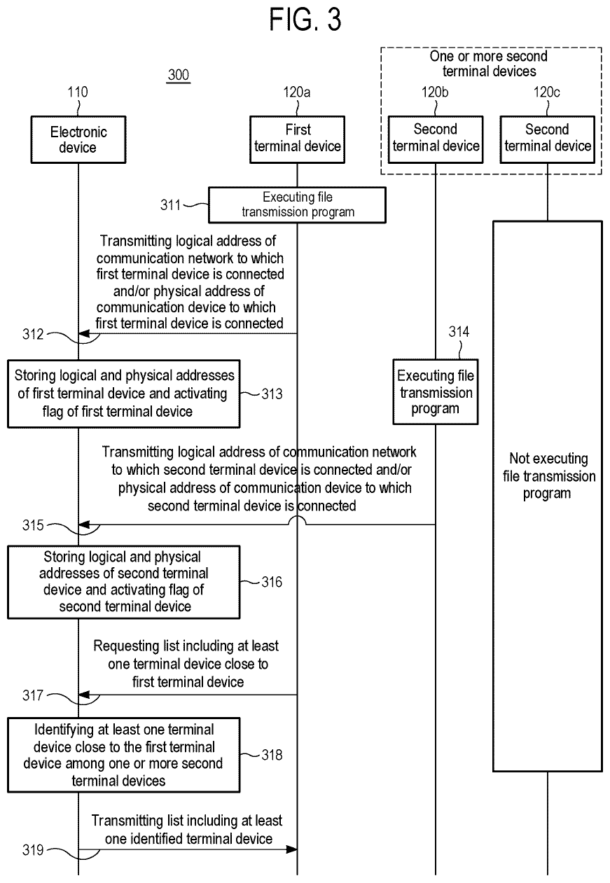

FIG. 3 is a flowchart 300 illustrating operations of a system 10 according to various embodiments of the present disclosure. Although it will be assumed herein for convenience of description that the number of the plurality of terminal devices 120 are three (120a, 120b, and 120c), but is not limited thereto.

Referring to the flowchart 300, the plurality of terminal devices 120 include a first terminal device 120a and one or more second terminal devices. The one or more second terminal devices include a second terminal device 120b and a second terminal device 120c. Each of the plurality of terminal devices 120 is communicatively connected with the electronic device 110. Each of the plurality of terminal devices 120 may transmit files to each other through the file transmission program installed therein. The electronic device 110 may be a server configured to manage and support the file transmission program. It will be assumed herein for convenience of description that the file transmission program is executed at (and logged in to) the first terminal device 120a and the second terminal device 120b, while the file transmission program is not executed at the second terminal device 120c.

The first terminal device 120a may execute the file transmission program in operation 311. For example, the first user of the first terminal device 120a may execute and log in to the file transmission program.

The first terminal device 120a may transmit a logical address of a communication network to which the first terminal device 120a is connected and/or a physical address of a communication device to which the first terminal device 120a is connected, to the electronic device 110 in operation 312. Concurrently while executing and logging in to the file transmission program, the first terminal device 120a may transmit the logical address of the communication network to which the first terminal device 120a is connected and/or the physical address of the communication device. For example, when the first terminal device 120a is communicatively connected to a wired LAN and connected to a first access point of the wired LAN, the first terminal device 120a may transmit an IP address of the wired LAN and a MAC address of the first access point to the electronic device 110.

As used herein, the IP address may be a logical address assigned from the wired LAN, and the MAC address may be a physical address (or hardware address) that the first access point has. The IP address of the wired LAN may be identical to the IP address of the first access point or the first terminal device 120a. For example, when the first terminal device 120a is connected to a router of the wired LAN, the first terminal device 120a may transmit the MAC address of the router of the wired LAN to the electronic device 110. For example, the first terminal device 120a may transmit not only the MAC address of the communication device, but also the unique identification number (for example, SSID or BSSID) to the electronic device 110.

In response to receiving the logical address and the physical address from the first terminal device 120a, the electronic device 110 may store the logical address and the physical address of the first terminal device 120a in the memory 113 and may activate the flag of the first terminal device 120a in operation 313. The electronic device 110 may update and store the logical address and/or the physical address received from the first terminal device 120a in the memory 113. In this case, the memory 113 may store not only the logical address of the communication network to which the first terminal device 120a is currently connected and/or the physical address of the currently connected communication device, but also the logical address of a previously connected communication network and/or the physical address of a previously connected communication device. That is, the memory 113 may store the record of logical addresses and physical addresses of the first terminal device 120a. Moreover, the memory 113 may store the record of logical addresses and/or physical addresses of the plurality of terminal devices, respectively, as well as that of the first terminal device 120a.

When the electronic device 110 activates the flag of the first terminal device 120a, the electronic device 110 may determine that the file transmission program is in an activated state at the first terminal device 120a. That is, the electronic device 110 may determine that the first terminal device 120a is in a state in which the same can perform file transmission (or reception). According to an embodiment, an activated flag may be set to be automatically deactivated when a predetermined time (for example, one minute) lapses from the timepoint of activation. For example, a timeout time (for example, one minute) may be set for the activated flag. The activated flag may be automatically deactivated when the predetermined time lapses, thereby improving search accuracy.

The second terminal device 120b may execute a file transmission program in operation 314. For example, the second user of the second terminal device 120b may execute and log in to the file transmission program.

The second terminal device 120b may transmit a logical address of a communication network to which the second terminal device 120b is connected and/or a physical address of a communication device to which the second terminal device 120b is connected, to the electronic device 110 in operation 315. Concurrently, while executing and logging in to the file transmission program, the second terminal device 120b may transmit the logical address of the communication network to which the second terminal device 120b is connected and/or the physical address of the communication device. For example, if the second terminal device 120b is communicatively connected to a wired LAN and connected to a second access point of the wired LAN, the second terminal device 120b may transmit the IP address of the wired LAN and/or the MAC address of the second access point to the electronic device 110.

In response to receiving the logical address and/or the physical address from the second terminal device 120b, the electronic device 110 may store the logical address and/or the physical address of the second terminal device 120b in the memory 113 and may activate a flag of the second terminal device 120b in operation 316. The electronic device 110 may update and store the logical address and/or the physical address received from the second terminal device 120b in the memory 113. In this case, the memory 113 may store not only the logical address of the communication network to which the second terminal device 120b is connected and/or the physical address of the connected communication device, but also a logical address of a previously connected communication network and/or a physical address of a previously connected communication device. That is, the memory 113 may store the record of logical addresses and/or and physical addresses of the second terminal device 120b.

The file transmission program may not be executed as the second terminal device 120c. In this case, a flag of the second terminal device 120c stored in the electronic device 110 may be in an inactivated state. If the timeout time of the flag of the first terminal device 120a and that of the flag of the second terminal device 120b have not yet lapsed, the flag of the first terminal device 120a and that of the flag of the second terminal device 120b may be in an activated state, and the flag of the second terminal device 120c may be in an inactivated state.

The first terminal device 120a may transmit a request for a list including at least one terminal device close to the first terminal device 120a to the electronic device 110 in operation 317. The first terminal device 120a may select a short-distance terminal device search function for searching for a terminal device close to the first terminal device 120a, thereby requesting the electronic device 110 to transmit the list.

The electronic device 110 may identify at least one terminal device close to the first terminal device 120a among one or more second terminal devices in operation 318. The electronic device 110 may identify at least one terminal device close to the first terminal device 120a among one or more second terminal devices, based on the logical address and/or physical address of the first terminal device 120a, logical addresses and physical addresses respectively associated with the one or more terminal devices, and/or flags indicating whether the one or more terminal devices are respectively activated.

According to an embodiment, when the flag of the second terminal device 120b is in an activated state, and when the physical address of the first terminal device 120a and the physical address of the second terminal device 120b are identical, the electronic device 110 may determine that the first terminal device 120a and the second terminal device 120b are located within a short distance (that is, close to each other). In this case, the electronic device 110 may identify the second terminal device 120b as a terminal device close to the first terminal device 120a.

According to an embodiment, if the flag of the second terminal device 120b is in an activated state, if the physical address of the first terminal device 120a and the physical address of the second terminal device 120b are different, if there is a past instance of the physical address of the first terminal device 120a and the physical address of the second terminal device 120b being identical, and if the logical address of the first terminal device 120a and the logical address of the second terminal device 120b are identical, the electronic device 110 may determine that the first terminal device 120a and the second terminal device 120b are located within a short distance (that is, close to each other). In this case, the electronic device 110 may identify the second terminal device 120b as a terminal device close to the first terminal device 120a.

According to an embodiment, when the flag of the second terminal device 120c is in an inactivated state, the electronic device 110 may determine that the first terminal device 120a and the second terminal device 120c are not located within a short distance. In this case, the electronic device 110 may determine that the second terminal device 120c is not close to the first terminal device 120a.

According to an embodiment, when the flag of the second terminal device 120b has been activated and then automatically deactivated when a predetermined time (timeout time) is lapsed, the electronic device 110 may determine that the first terminal device 120a and the second terminal device 120b are not located within a short distance. In this case, the electronic device 110 may determine that the second terminal device 120b is not close to the first terminal device 120a.

The electronic device 110 may transmit a list including at least one identified terminal device to the first terminal device 120a in operation 319. For example, when the electronic device 110 has identified that the second terminal device 120b is close to the first terminal device 120a and that the second terminal device 120c is not close to the first terminal device 120a, the electronic device 110 may transmit a list including the second terminal device 120b to the first terminal device 120a.

According to an embodiment of the present disclosure, the electronic device 110 may identify at least one terminal device close to the first terminal device by using the logical address and/or the physical address of each of the plurality of terminal devices 120. According to the present disclosure, a range (or area) wider than what may be searched when BLE or GPS technology is used, may be searched and the search accuracy may be improved.

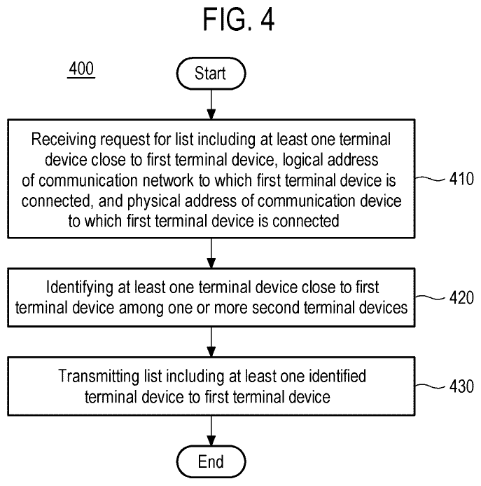

FIG. 4 is a flowchart 400 illustrating operations of an electronic device 110 according to various embodiments of the present disclosure. Descriptions overlapping with what was described with reference to FIG. 3 will not be repeated herein. Referring to the flowchart 400, the electronic device 110 may receive, from the first terminal device 120a, a request for a list including at least one terminal device close to the first terminal device 120a, the logical address of a communication network to which the first terminal device 120a is connected, and the physical address of a communication device to which first terminal device 120a is connected, in operation 410.

The electronic device 110 may identify at least one terminal device close to the first terminal device 120a among one or more second terminal devices, based on the logical address and the physical address of the first terminal device 120a, logical addresses, physical addresses, and flags associated with one or more second terminal devices (for example, second terminal device 120b and second terminal device 120c in FIG. 3), respectively, in operation 420. The logical address of the communication network respectively associated with the one or more second terminal devices, the physical address of the communication device respectively associated with the one or more second terminal devices, and/or a flag indicating whether the one or more second terminal devices are respectively activated may be stored in the memory 113 of the electronic device 110.

According to an embodiment, the electronic device 110 may identify that a terminal device having an activated flag and having the same physical address as that of the first terminal device 120a, among the one or more second terminal devices, is a terminal device close to the first terminal device 120a. It will be assumed in the present embodiment that the MAC address of the first terminal device 120a is X. If the flag of the second terminal device 120b is activated, and if the MAC address of the second terminal device 120b is X, the electronic device 110 may identify that the second terminal device 120b is close to the first terminal device 120a.

If the flag of the second terminal device 120c is activated, and if the MAC address of the second terminal device 120c is Y, the electronic device 110 may determine that the second terminal device 120c is not close to the first terminal device 120a. When the flag of the second terminal device 120c is deactivated (for example, when no file transmission program has been executed in the second terminal device 120c, or when the flag of the second terminal device 120c has been activated and, with a lapse of time-out time, deactivated), the electronic device 110 may determine that the second terminal device 120c is not close to the first terminal device 120a.

According to an embodiment, the electronic device 110 may identify that a second terminal device having an activated flag, having a record of having the same physical address as that of the first terminal device 120a, and having the same logical address as that of the first terminal device 120a, among one or more second terminal devices, is a terminal device close to the first terminal device 120a. It will be assumed in the present embodiment that the physical address of the first terminal device 120a is X, and the logical address thereof is N. If the flag of the second terminal device 120b is activated, if the physical address of the second terminal device 120b is currently Y but has a record of being X, and if the logical address of the second terminal device 120b is N, the electronic device 110 may identify that the second terminal device 120b is close to the first terminal device 120a. That is, the second terminal device 120b has a record of having the same physical address as that of the first terminal device 120a and has the same logical address as that of the first terminal device 120a, and the electronic device 110 may accordingly identify that the second terminal device 120b is close to the first terminal device 120a.

If the flag of the second terminal device 120c is activated, if the physical address of the second terminal device 120c is currently Y but has a record of being X, and if the logical address of the second terminal device 120c is M, the electronic device 110 may identify that the second terminal device 120c is not close to the first terminal device 120a. That is, the second terminal device 120c currently has a physical address different from that of the first terminal device 120a and also has a different logical address, and the electronic device 110 may accordingly identify that the second terminal device 120c is not close to the first terminal device 120a.

The electronic device 110 may transmit a list including the one or more identified terminal devices to the first terminal device 120a in operation 430.

Therefore, the first terminal device 120a may receive a user input for selecting a third terminal device to which a specific file is to be transmitted, among the one or more terminal devices included in the received list. For example, the first terminal device 120a may receive a user input for selecting a second terminal device 120b, among the one or more terminal devices included in the received list, as the third terminal device to which a specific file is to be transmitted. Based on the user input, the first terminal device 120a may determine to transmit a specific file to the third terminal device (that is, the selected second terminal device 120b). In this case, the first terminal device 120a may transmit a specific file to the electronic device 110 and may request the electronic device 110 to transmit the specific file to the third terminal device.

In response to receiving the request, the electronic device 110 may transmit a request to the third terminal device so as to confirm whether or not to allow transmission of the specific file. In response to receiving the request, the third terminal device may receive a user input for determining whether or not to allow transmission of the specific file. For example, the third terminal device may display a popup window including the wording “First terminal device 120a is to transmit a file. Would you allow file transmission?”. The user of the third terminal device may or may not allow the file transmission from the first terminal device 120a through the popup window.

If the user of the third terminal device chooses to allow the transmission of the specific file, the third terminal device may transmit a response to the electronic device 110 so as to allow the transmission of the specific file. In this case, the electronic device 110 may transmit the specific file to the third terminal device.

If the user of the third terminal device decides not to allow the transmission of the specific file, the third terminal device may transmit a response to the electronic device 110 indicating that the transmission of the specific file is not allowed. In this case, the electronic device 110 may not transmit the specific file to the third terminal device. The electronic device 110 may delete the specific file received from the first terminal device 120a without separately storing the same.

According to an embodiment of the present disclosure, an electronic device may (1) receive, from a first terminal device, a request for a list including at least one terminal device close to the first terminal device, a logical address (for example, an IP address) of a communication network to which the first terminal device is connected, and a physical address (for example, a MAC address) of a communication device to which the first terminal device is connected, (2) may identify at least one terminal device close to the first terminal device among the one or more second terminal devices, based on a logical address and a physical address of the first terminal device, and logical addresses, physical addresses, and flags respectively associated with the one or more second terminal devices, and (3) may transmit a list including the at least one identified terminal device to the first terminal device. According to the present disclosure, a range (or area) wider than what may be searched when BLE or GPS technology is used, may be searched and search accuracy may be improved. For example, even in indoors, at least one terminal device close to the first terminal device may be accurately identified.

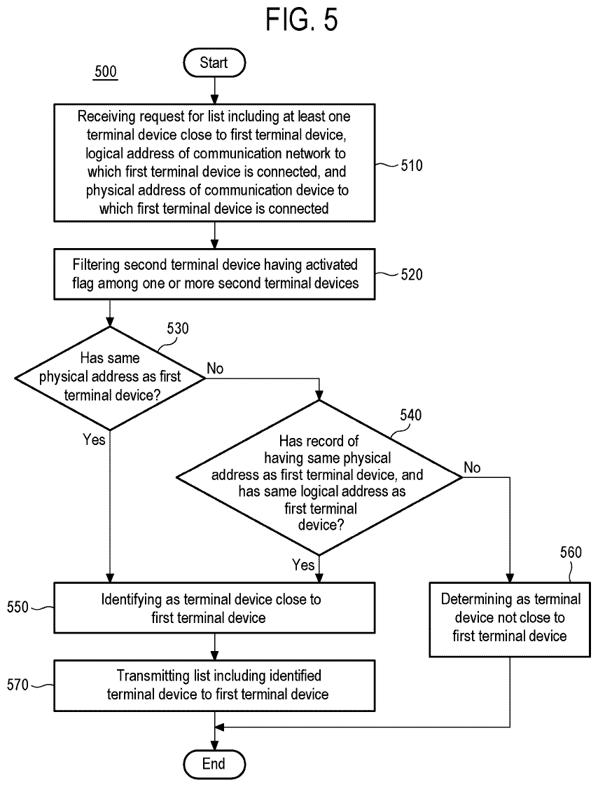

FIG. 5 is a flowchart 500 illustrating operations of an electronic device 110 according to various embodiments of the present disclosure. Descriptions overlapping with what was described with reference to FIG. 3 and FIG. 4 will not be repeated herein. Referring to the flowchart 500, the electronic device 110 may receive, from the first terminal device 120a, a request for a list including at least one terminal device close to the first terminal device 120a, the logical address of a communication network to which the first terminal device 120a is connected, and the physical address of a communication device to which the first terminal device 120a is connected, in operation 510. The received logical address and/or physical address of the first terminal device 120a may be stored in the memory 113.

The electronic device 110 may filter a second terminal device having an activated flag among one or more second terminal devices in operation 520. For example, a second terminal device having a deactivated flag, among the one or more second terminal devices, cannot perform file transmission, and may be excluded from proximate terminal devices capable of performing file transmission with the first terminal device 120a. For example, if the second terminal device 120c has a deactivated flag, the electronic device 110 may filter the second terminal device 120c so as to exclude the same from proximate terminal devices capable of performing file transmission with the first terminal device 120a.

The electronic device 110 may determine in operation 530 whether each second terminal device having an activated flag has the same physical address as that of the first terminal device 120a. The electronic device 110 may identify, among second terminal devices having an activated flag, a terminal device having the same physical address as that of the first terminal device 120a. For example, the electronic device 110 may identify, among second terminal devices having an activated flag, a terminal device having the same MAC address as that of the first terminal device 120a.

If a second terminal device having an activated flag has the same physical address as that of the first terminal device 120a, the electronic device 110 may proceed to operation 550 (“Yes” in operation 530) and may identify the corresponding second terminal device as a terminal device close to the first terminal device 120a. For example, if the second terminal device 120b has an activated flag, and if the MAC address of the second terminal device 120b is identical to that of the first terminal device 120a, the electronic device 110 may identify the second terminal device 120b as a terminal device close to the first terminal device 120a.

If a second terminal device having an activated flag has a physical address different from that of the first terminal device 120a, the electronic device 110 may proceed to operation 540 (“No” in operation 530) and may identify whether the corresponding second terminal device has a record of having the same physical address as that of the first terminal device 120a. For example, the electronic device 110 may identify whether the corresponding terminal device, although currently having a physical address different from that of the first terminal device 120a, has a record of having the same physical address as that of the first terminal device 110a, and whether the logical address of the first terminal device 120a is identical to that of the corresponding specific terminal device.

When the corresponding second terminal device has a record of having the same physical address as that of the first terminal device 120a, and when the corresponding second terminal device has the same logical address as that of the first terminal device 120a, the electronic device 110 may proceed to operation 550 (“Yes” in operation 540) and may identify that the corresponding second terminal device is close to the first terminal device 120a.

When the corresponding second terminal device has no record of having the same physical address as that of the first terminal device 120a, or when the corresponding second terminal device has a logical address different from as that of the first terminal device 120a, the electronic device 110 may proceed to operation 560 (“No” in operation 540) and may determine that the corresponding second terminal device is not close to the first terminal device 120a.

The electronic device 110 may transmit a list including at least one terminal device identified as being close to the first terminal device 120a to the first terminal device 120a in operation 570.

Hereinafter, various scenarios in which the system 10 of the present disclosure is used to transmit a specific file will be described. The first scenario assumes that a file is transmitted between a first user and a second user working at the same office in the same building. The first terminal device 120a of the first user and the second terminal device 120b of the second user may be connected to the same access point at the same office, thereby using the same communication network. In this case, a physical address (MAC address) of the communication device (an access point) connected to the first terminal device 120a is identical to a physical address (a MAC address) of the communication device (the access point) connected to the second terminal device 120b. In this case, the electronic device 110 may identify, based on the above-mentioned operations that the second terminal device 120b is close to the first terminal device 120a. Therefore, in this scenario, the first user may transmit a specific file to the second terminal device 120b of the second user located within a short distance through the first terminal device 120a.

The second scenario assumes that a file is transmitted between a first user and a second user who used to work at the same office in the same building, but currently work at different offices (for example, at offices on different floors) in the same building. In this case, the first terminal device 120a of the first user and the second terminal device 120b of the second user may have been connected to the same first access point in the past. At the present time, however, the first terminal device 120a of the first user may be still connected to the first access point, and the second terminal device 120b of the second user may be connected to a new second access point. The first and second access points may be installed at different offices of the same building and may have different physical addresses (MAC addresses) but the same logical address (IP address) of the connected communication network. That is, the second terminal device 120b has a record of having the same physical address (MAC address) as that of the first terminal device 120a and has the same logical address as that of the first terminal device 120a. In this case, based on the above-mentioned operations, the electronic device 110 may identify that the second terminal device 120b is close to the first terminal device 120a. Therefore, in this scenario, the first user may transmit a specific file to the second terminal device 120b of the second user located within a short distance through the first terminal device 120a.

The third scenario assumes that a file is transmitted between a first user and a second user who have never worked at the same office or in the same building, and who currently work at different offices (for example, at offices on different floors). In this case, the first terminal device 120a of the first user is connected to a first access point, and the second terminal device 120b of the second user is connected to a second access point. The physical address (MAC address) of the first access point is different from that of the second access point. Moreover, the second terminal device has no record of having the same physical address as that of the first terminal device because the first terminal device 120a of the first user has never been at the same office with the second terminal device 120c of the second user. In this case, based on the above-mentioned operations, the electronic device 110 may identify that the second terminal device 120b is not close to the first terminal device 120a. Therefore, in this scenario, the first user cannot transmit a specific file to the second terminal device 120b of the second user through the first terminal device 120a.

According to various embodiments of the present disclosure, search accuracy may be improved because the plurality of terminal devices are deemed to be close to each other not only when they have the same physical address, but also when they currently have different physical addresses but have the same logical address. A plurality of access points and/or routers may be connected at a single logical address (for example, IP address), and the logical address may be the same even when physical addresses are different. That is, there is a high probability that terminal devices are located within a short distance in the above-mentioned case as well. According to the present embodiment, a terminal device within a short distance may be searched without omitting the above-mentioned case.

According to various embodiments disclosed herein, when a file transmission program is executed (or logged in) at a terminal device, the terminal device may transmit a logical address and a physical address of the terminal device to an electronic device 110. According to another embodiment, when a file transmission program is being executed in a terminal device, the terminal device may periodically transmit a logical address and a physical address of the terminal device to an electronic device 110. For example, the terminal device may transmit the logical address and/or physical address of the terminal device to the electronic device 110 once every five minutes. In this case, the cycle at which the logical address and/or physical address are transmitted may be set to be longer than or equal to the time-out time after which an activated flag is deactivated. According to another embodiment, every time a specific action occurs in a file transmission program executed at a terminal device, the terminal device may transmit the logical address and/or the physical address of the terminal device to the electronic device 110. For example, the terminal device may transmit the logical address and/or physical address to the electronic device 110 every time functions of the file transmission program are selected. Every time the logical address and/or the physical address are transmitted to the electronic device 110 in this manner, the electronic device 110 may change the flag of the corresponding terminal device so as to indicate that the corresponding terminal device has been activated.

According to various embodiments disclosed herein, although it has been assumed that the electronic device 110 assigns a flag to each of the plurality of terminal devices to indicate whether the same is activated or not, the electronic device 110 may identify in real time whether each of the plurality of terminal devices is in an activated state.

Although process steps, method steps, algorithms, and the like have been described in a successive order with regard to the flowcharts illustrated in FIG. 3, FIG. 4, and FIG. 5, such processes, methods, and algorithms may be configured to operate in any appropriate order. In other words, steps of processes, methods, and algorithms described in various embodiments of the present disclosure are not necessarily performed in the order described in the present disclosure. In addition, some steps may be described as being performed asynchronously, such steps may be performed synchronously in other embodiments. In addition, an example of a process by illustration in the drawings does not mean that the exemplified processes exclude other changes and modifications related thereto, does not mean that the exemplified process or any of its steps is essential to one or more of various embodiments of the present disclosure, and does not mean that the exemplified process is preferable.

While the foregoing methods have been described with respect to particular embodiments, these methods may also be implemented as computer-readable codes on a computer-readable recording medium. The computer-readable recoding medium includes any kind of data storage devices that can be read by a computer system. Examples of the computer-readable recording medium includes ROM, RAM, CD-ROM, magnetic tape, floppy disk, optical data storage device and the like. Also, the computer-readable recoding medium can be distributed to the computer systems which are connected through a network so that the computer-readable codes can be stored and executed in a distributed manner. Further, the functional programs, codes and code segments for implementing the foregoing embodiments can easily be inferred by programmers in the art to which the present disclosure pertains.

Hereinafter, various embodiments of the present disclosure will be additionally described.

### [Additional Description 1]

An electronic device including:
a communication circuit communicatively connected with a first terminal device and one or more second terminal devices;
one or more memories configured to store logical addresses of communication networks respectively associated with the one or more second terminal devices, physical addresses of communication devices respectively associated with the one or more second terminal devices, and flags respectively indicating whether the one or more second terminal devices are activated; and
one or more processors,
wherein the one or more processors are configured to
receive, from the first terminal device, a request for a list including at least one terminal device close to the first terminal device, a logical address of a communication network to which the first terminal device is connected, and a physical address of a communication device to which the first terminal device is connected,
identify the at least one terminal device close to the first terminal device among the one or more second terminal devices, based on the logical address and the physical address of the first terminal device, and the logical addresses, the physical addresses, and the flags associated with the one or more second terminal devices, respectively, and
transmit the list including the at least one identified terminal device to the first terminal device.

### [Additional Description 2]

The electronic device of additional description 1,
wherein the one or more processors are configured to identify, among the one or more second terminal devices, a second terminal device having an identical physical address as the first terminal device and an activated flag as the at least one terminal device.

### [Additional Description 3]

The electronic device of additional description 1 or 2,
wherein the one or more processors are configured to further identify, among the one or more second terminal devices, as the at least one terminal device a second terminal device having a record of having an identical physical address as the first terminal device, an identical logical address as the first terminal device, and having an activated flag.

### [Additional Description 4]

The electronic device of one of additional descriptions 1 to 3,
wherein the one or more processors are configured to
receive, from the first terminal device, a specific file and a request for transmitting the specific file to a third terminal device among the at least one terminal device included in the list, and
transmit, to the third terminal device, a request for confirming whether or not to allow the transmitting of the specific file.

### [Additional Description 5]

The electronic device of additional description 4,
wherein the one or more processors are configured to transmit the specific file to the third terminal device if a response allowing the transmitting of the specific file is received from the third terminal device.

### [Additional Description 6]

The electronic device of additional description 4,
wherein the one or more processors are configured to not transmit the specific file to the third terminal device if a response not allowing the transmitting of the specific file is received from the third terminal device.

### [Additional Description 7]

The electronic device of one of additional descriptions 1 to 6,
wherein the one or more processors are configured to
receive, from a specific terminal device included in the one or more second terminal devices, a logical address of a communication network to which the specific terminal device is connected and a physical address of a communication device to which the specific terminal device is connected, and
activate a flag of the specific terminal device in response to receiving the logical address or the physical address of the specific terminal device.

### [Additional Description 8]

The electronic device of additional description 7,
wherein the flag of the specific terminal device is set to be deactivated when a predetermined time lapses from a timepoint of activation.

### [Additional Description 9]

The electronic device of description 8,
wherein the predetermined time is one minute.

### [Additional Description 10]

The electronic device of one of additional descriptions 1 to 9,
wherein the communication device to which the first terminal device is connected is a router or an access point.

### [Additional Description 11]

The electronic device of one of additional descriptions 1 to 10,
wherein the logical address is an Internet Protocol (IP) address.

### [Additional Description 12]

The electronic device of one of additional descriptions 1 to 11,
wherein the physical address is a Media Access Control (MAC) address.

### [Additional Description 13]

The electronic device of one of additional descriptions 1 to 12,
wherein the one or more processors are configured to
receive, from the first terminal device, a unique identification number of the communication device to which the first terminal device is connected, and
store the unique identification number in the one or more memories.

### [Additional Description 14]

The electronic device of description 13,
wherein the unique identification number is a SSID of the communication device.

### [Additional Description 15]

The electronic device of description 13,
wherein the unique identification number is a BSSID of the communication device.

### [Additional Description 16]

A method including:
receiving, from a first terminal device, a request for a list including at least one terminal device close to the first terminal device, a logical address of a communication network to which the first terminal device is connected, and a physical address of a communication device to which the first terminal device is connected;
identifying the at least one terminal device close to the first terminal device among the one or more second terminal devices, based on the logical address and the physical address of the first terminal device, and logical addresses, physical addresses, and flags respectively associated with the one or more second terminal devices, respectively; and
transmitting the list including the at least one identified terminal device to the first terminal device.

### [Additional Description 17]

A non-transitory computer-readable recording medium in which a program to be executed on a computer is recorded, the program including executable commands which, when executed by one or more processors, cause the processors to:
receive, from a first terminal device, a request for a list including at least one terminal device close to the first terminal device, a logical address of a communication network to which the first terminal device is connected, and a physical address of a communication device to which the first terminal device is connected;
identify the at least one terminal device close to the first terminal device among the one or more second terminal devices, based on the logical address and the physical address of the first terminal device, and logical addresses, physical addresses, and flags respectively associated with the one or more second terminal devices, respectively; and
transmit the list including the at least one identified terminal device to the first terminal device.

Although the technical spirit of the present disclosure has been described by the examples described in some embodiments and illustrated in the accompanying drawings, it should be noted that various substitutions, modifications, and changes can be made without departing from the scope of the present disclosure which can be understood by those skilled in the art to which the present disclosure pertains. In addition, it should be noted that that such substitutions, modifications, and changes are intended to fall within the scope of the appended claims.

1. An electronic device comprising:
a communication circuit communicatively connected with a first terminal device and one or more second terminal devices;
one or more memories configured to store logical addresses of communication networks respectively associated with the one or more second terminal devices, physical addresses of communication devices respectively associated with the one or more second terminal devices, and flags respectively indicating whether the one or more second terminal devices are activated; and
one or more processors,
wherein the one or more processors are configured to:
receive, from the first terminal device, a request for a list including at least one terminal device close to the first terminal device, a logical address of a communication network to which the first terminal device is connected, and a physical address of a communication device to which the first terminal device is connected;
identify the at least one terminal device close to the first terminal device among the one or more second terminal devices, based on the logical address and the physical address of the first terminal device, and the logical addresses, the physical addresses, and the flags associated with the one or more second terminal devices, respectively; and
transmit the list including the at least one identified terminal device to the first terminal device.

2. The electronic device of claim 1, wherein the one or more processors are configured to identify, among the one or more second terminal devices, a second terminal device having an identical physical address as the first terminal device and an activated flag as the at least one terminal device.

3. The electronic device of claim 2, wherein the one or more processors are configured to further identify, as the at least one terminal device among the one or more second terminal devices, a second terminal device having a record of having an identical physical address as the first terminal device, having an identical logical address as the first terminal device, and an activated flag.

4. The electronic device of claim 1, wherein the one or more processors are configured to:
receive, from the first terminal device, a specific file and a request for transmitting the specific file to a third terminal device among the at least one terminal device included in the list; and
transmit, to the third terminal device, a request for confirming whether or not to allow the transmitting of the specific file.

5. The electronic device of claim 4, wherein the one or more processors are configured to transmit the specific file to the third terminal device if a response allowing the transmitting of the specific file is received from the third terminal device.

6. The electronic device of claim 4, wherein the one or more processors are configured to not transmit the specific file to the third terminal device if a response not allowing the transmitting of the specific file is received from the third terminal device.

7. The electronic device of claim 1, wherein the one or more processors are configured to:
receive, from a specific terminal device included in the one or more second terminal devices, a logical address of a communication network to which the specific terminal device is connected and a physical address of a communication device to which the specific terminal device is connected; and
activate a flag of the specific terminal device in response to receiving the logical address or the physical address of the specific terminal device.

8. The electronic device of claim 7, wherein the flag of the specific terminal device is set to be deactivated when a predetermined time lapses from a timepoint of activation.

9. The electronic device of claim 8, wherein the predetermined time is one minute.

10. The electronic device of claim 1, wherein the communication device to which the first terminal device is connected is a router or an access point.

11. The electronic device of claim 1, wherein the logical address is an Internet Protocol (IP) address.

12. The electronic device of claim 1, wherein the physical address is a Media Access Control (MAC) address.

13. The electronic device of claim 12, wherein the one or more processors are configured to:
receive, from the first terminal device, a unique identification number of the communication device to which the first terminal device is connected; and
store the unique identification number in the one or more memories.

14. The electronic device of claim 13, wherein the unique identification number is a Service Set Identifier (SSID) of the communication device.

15. The electronic device of claim 13, wherein the unique identification number is a Basic Service Set Identifier (BSSID) of the communication device.

16. A method comprising:
receiving, from a first terminal device, a request for a list including at least one terminal device close to the first terminal device, a logical address of a communication network to which the first terminal device is connected, and a physical address of a communication device to which the first terminal device is connected;
identifying the at least one terminal device close to the first terminal device among the one or more second terminal devices, based on the logical address and the physical address of the first terminal device, and logical addresses, physical addresses, and flags respectively associated with the one or more second terminal devices; and
transmitting the list including the at least one identified terminal device to the first terminal device.

17. A non-transitory computer-readable recording medium in which a program to be executed on a computer is recorded, the program comprising executable commands which, when executed by one or more processors, cause the processors to:
receive, from a first terminal device, a request for a list including at least one terminal device close to the first terminal device, a logical address of a communication network to which the first terminal device is connected, and a physical address of a communication device to which the first terminal device is connected;
identify the at least one terminal device close to the first terminal device among the one or more second terminal devices, based on the logical address and the physical address of the first terminal device, and logical addresses, physical addresses, and flags respectively associated with the one or more second terminal devices, respectively; and
transmit the list including the at least one identified terminal device to the first terminal device.
